(19) United States
(12) Patent Application Publication
(10) Pub. No.: US 2018/0319486 A1
(43) Pub. Date: Nov. 8, 2018

(54) THRUSTING ROCKETS FOR ENHANCING EMERGENCY AUTOROTATION

(71) Applicant: NEWROCKET LTD., Beer Sheva (IL)

(72) Inventors: Moti ELYASHIV, Netanya (IL); Reuben RAZ, Reut (IL); Zohar SCHLAGMAN, Tel-Mond (IL)

(21) Appl. No.: 15/768,052

(22) PCT Filed: Oct. 14, 2016
(86) PCT No.: PCT/IL2016/051119

§ 371 Date: Apr. 13, 2018

(30) Foreign Application Priority Data
Oct. 13, 2015 (IL) 242061

(51) Int. Cl. B64C 27/00; B64D 27/02; F02K 9/95; F02K 9/24; F02K 9/46; F02K 9/70; F02K 9/72

(52) U.S. Cl. CPC B64C 27/006; B64D 27/023; F02K 9/95; F05D 2270/09; F02K 9/46; F02K 9/70; F02K 9/72; F02K 9/24

(57) ABSTRACT

There is provided, in accordance some embodiment, a method for enhancing autorotation performance of a rotary-wing aircraft in emergency events. The method comprises an action of receiving a request for emergency thrust from a user interface. The method comprises an action of sending a start command to an emergency engine coupled to a rotary-wing aircraft following the request. The method comprises an action of thrusting the rotary-wing aircraft coupled to the emergency engine in a direction substantially of a longitudinal axis of the rotary-wing aircraft, thereby enhancing autorotation performance of the rotary-wing air-craft in an emergency event.

### RELATED APPLICATIONS

This application is a National Phase of PCT Patent Application No. PCT/IL2016/051119 having International filing date of Oct. 13, 2016, which claims the benefit of priority of Israel Patent Application No. 242061 filed on Oct. 13, 2015. The contents of the above applications are all incorporated by reference as if fully set forth herein in their entirety.

### FIELD OF THE INVENTION

The invention relates to the field of emergency aids for aircraft.

### BACKGROUND

Helicopter operation may have four flight control inputs comprising a collective lever (or collective), a cyclic stick (or cyclic), anti-torque pedals (or pedals), and a throttle. For example, the collective changes the pitch angle of all rotor blades equally to control the angle of attack of the rotor blades thereby causing the helicopter to ascend or descend. For example, the pedals control the pitch of the tail rotor blades to control yaw rate. For example, the pedals control the pitch of two counter-rotating rotor blades to control yaw rate. For example, the throttle controls the power of the engine. Pitch, yaw, and roll may be referred to as body angles of an aircraft or attitude.

In some helicopters, the cyclic and collective are linked together by a mixing unit, which is a device that combines the inputs from the cyclic and collective together and sends the “mixed” input to the control rotor surfaces to achieve the desired result.

The collective pitch control, or collective lever, may be located on the left side of an operator seat, optionally with an adjustable friction control to prevent inadvertent movement. The collective may change the pitch angle of the main rotor blades collectively, such as all at the same time, and independently of the rotor blade position. When the collective is changed, all blades change equally, and the helicopter increases or decreases the total lift from the rotor. This may cause a climb or descent. When the helicopter is pitched forward, an increase in total lift may produce a velocity increase with a given amount of ascent.

The cyclic control is usually located between the pilot's legs and is commonly called the cyclic stick or simply cyclic. On a helicopter, the cyclic may be similar to a joystick. The control is called the cyclic because it may vary the pitch of the rotor blades throughout each revolution of the main rotor system, such as through each cycle of rotation, to develop unequal rotor blade angles. The result is to tilt the rotor disk in a particular direction, resulting in the helicopter moving in that direction. When the pilot pushes the cyclic forward, the rotor disk tilts forward, and the rotor blades produce a thrust in the forward direction. When the pilot pushes the cyclic to the side, the rotor disk tilts to that side and produces thrust in that direction, causing the helicopter to move sideways.

The anti-torque pedals may be located in the position of the rudder pedals in an airplane, and may serve similar purposes. The direction that the nose of the aircraft points is controlled by the pedals. The pedal may change the tail rotor blade pitch, increasing or reducing tail rotor thrust. Thus the nose yaw is changed in the direction of the applied pedal.

The throttle control determines the power of the engine, which may be connected to the rotor by a transmission. The throttle setting may maintain enough engine power to keep the rotor speed within the limits to produce enough lift for flight. The throttle control may be a single or dual motorcycle-style twist grip mounted on the collective control, while some multi-engine helicopters may have power levers. A pilot may manipulate the throttle to maintain rotor speed. Governors or other electro-mechanical control systems may be used to maintain rotor speed and to help the pilot with this task.

An autorotation flight-mode (AFM) maneuver may be performed by a pilot of a rotary-wing aircraft, such as a helicopter, and the like, for safe landing. AFM may be used to reach a safe landing in an emergency event, such as when a main engine and/or transmission failure occurs, or the like.

In a normal AFM aircraft maneuver, the potential energy, such as altitude, is transformed in part to conserve rotation of the rotor, thus maintaining the rotor lift. As a result of the AFM the flight duration, controllability, and the overall survivability in cases where emergency landing is expected may be improved.

For example, in helicopter piloting, AFM refers to a descending maneuver where the engine is disengaged from the main rotor system and the rotor blades are driven solely by the upward flow of air through the rotor. The freewheeling unit is a special clutch mechanism that disengages the rotors anytime the engine shaft rotation speed is less than the rotor rotation speed. When the engine fails or goes idle, the freewheeling unit allows the main rotor to rotate freely.

The most common reason for AFM is an engine malfunction or failure, but autorotation may also be performed in the event of a complete tail rotor failure, or following loss of tail-rotor effectiveness, since there is virtually no torque produced in an autorotation. In most cases, a successful landing depends on the helicopter's height and airspeed at the commencement of autorotation.

In AFM, when the engine fails, the main rotor blades produce lift and thrust from their angle of attack and velocity. By immediately lowering the collective, such as lowering the blade's pitch, which may be done in case of an engine failure, the helicopter begins an immediate descent, producing an upward flow of air through the rotor system. This upward flow of air through the rotor provides sufficient thrust to maintain rotor rpm throughout the descent. When the tail rotor is driven by the main rotor transmission during autorotation, heading control is maintained as in normal flight.

When landing from an autorotation, a flare maneuver is used to decrease the rate of descent and make a soft landing. Each type of helicopter may have a specific airspeed at which a power-off glide is most efficient, and maximum range may be achieved. A sufficient airspeed in the case of AFM is the one that combines the glide range and rate of descent to allow a safe landing. For example, a safe landing location may be directly below the aircraft during an engine failure and the aircraft will spiral downward in a normal AFM to a safe landing. For example, a safe landing location may be at a distance of 1000 meters from the aircraft when engine failure occurs and the aircraft uses a normal AFM under minimum rate of descent to reach the safe landing location. The specific airspeed may be different for each type of helicopter, yet certain factors, such as air density, altitude, wind, and the like, may affect most aircraft in similar manners. The specific airspeed for AFM is established for each type of helicopter on the basis of average weather, wind conditions, and normal loading.

The foregoing examples of the related art and limitations related therewith are intended to be illustrative and not exclusive. Other limitations of the related art will become apparent to those of skill in the art upon a reading of the specification and a study of the figures.

### SUMMARY

The following embodiments and aspects thereof are described and illustrated in conjunction with systems, tools, and methods which are meant to be exemplary and illustrative, not limiting in scope.

There is provided, in accordance some embodiment, a method for enhancing autorotation of a rotary-wing aircraft in emergency events. The method comprises an action of receiving a request for emergency thrust from a user interface. The method comprises an action of sending a start command to an emergency engine coupled to a rotary-wing aircraft following the request. The method comprises an action of thrusting the rotary-wing aircraft coupled to the emergency engine in a direction substantially of a longitudinal axis of the rotary-wing aircraft, thereby enhancing autorotation performance of the rotary-wing aircraft in an emergency event.

In some embodiments, the enhancing may be by increasing a flight range of the rotary-wing aircraft, increasing a flight time of the rotary-wing aircraft, decreasing a rate of descent of the rotary-wing aircraft, and/or increasing an airspeed of the rotary-wing aircraft.

In some embodiments, the thrusting is provided for a time between 1 second and 10 minutes.

In some embodiments, the thrusting is of a variable force, modulated by a user input received from the user interface.

In some embodiments, the emergency engine is a rocket propulsion engine. In some embodiments, the rocket propulsion engine comprises one or more propellants selected from the group consisting of: a solid rocket propellant, a liquid rocket propellant, a gas rocket propellant, a gel rocket propellant, and a hybrid propellant comprising a solid propellant and at least one of a liquid, gas, and gel rocket propellants.

In some embodiments, the emergency engine is a gel-propelled rocket engine.

In some embodiments, the gel-propelled rocket engine comprises a pressure feed.

In some embodiments, the emergency event is an engine failure, a vortex ring state, a tail rotor failure, and a loss of tail-rotor effectiveness (LTE).

In some embodiments, the emergency engine is angled relative to said longitudinal axis to pass through a center of mass of the rotary-wing aircraft and avoid affecting an attitude of the rotary-wing aircraft during flight thus avoiding negative effect on the control and stability of said rotary-wing aircraft.

There is provided, in accordance some embodiment, an emergency engine system for enhancing autorotation of a rotary-wing aircraft in emergency events. The emergency engine system comprises a user interface in a cockpit of a rotary-wing aircraft, where the user interface comprises one or more control for receiving a request for emergency thrust from a pilot of the rotary-wing aircraft. The emergency engine system comprises one of more emergency engines mechanically coupled to the rotary-wing aircraft, where the emergency engine(s) is logically connected to the user interface for receiving a start command from the user interface following the request. When the emergency engine(s) receive the start command from the user interface, the rotary-wing aircraft coupled to the emergency engine(s) is thrusted in a direction substantially of a longitudinal axis of said rotary-wing aircraft, thereby enhancing autorotation performance of to the rotary-wing aircraft in an emergency event.

In some embodiments, the enhancing may be by increasing a flight range of the rotary-wing aircraft, increasing a flight time of the rotary-wing aircraft, decreasing a rate of descent of the rotary-wing aircraft, and/or increasing an airspeed of the rotary-wing aircraft.

In some embodiments, the emergency engine system further comprises a pressurizing system for injecting one or more propellants into one or more combustion chamber of respective the emergency engine(s), where the propellant(s) are ignited in the combustion chamber(s) thereby providing thrust to the rotary-wing aircraft.

In some embodiments, the propellant(s) comprises a gel-based rocket propellant.

In some embodiments, the propellant(s) are selected from the group consisting of: a solid rocket propellant, a liquid rocket propellant, a gas rocket propellant, a gel rocket propellant, and a hybrid propellant comprising a solid propellant and at least one of a liquid, gas, and gel rocket propellants.

In some embodiments, the emergency engine system further comprises a control unit for receiving the pilot input from the user interface.

In some embodiments, the emergency engine system further comprises one or more valve for activating the emergency engine(s).

In some embodiments, the pressurizing system comprises one or more pressure tank.

In some embodiments, the pressurizing system comprises a piston, a bladder, and/or a diaphragm incorporated in respective propellant tank(s).

In some embodiments, the emergency engine system further comprises one or more nozzles connected to respective combustion chamber(s).

In some embodiments, the nozzle(s) are moveable nozzle(s).

In some embodiments, the nozzle(s) comprise a deflector to direct some of said thrust in a lateral direction to control a change in body angle of the aircraft.

In some embodiments, the control unit receives sensor values from at least one of the aircraft and at least one dedicated engine sensors for activating the at least one emergency engine.

In some embodiments, the control unit activates emergency engine(s) automatically.

In some embodiments, the control unit activates the emergency engine(s) at least in part automatically.

In some embodiments, the control unit receives sensor values from the aircraft and/or one or more dedicated sensors.

In some embodiments, the emergency engine(s) comprise a left-side emergency sub-engine coupled to a left side of the aircraft and a right-side emergency sub-engine coupled to a right side of the aircraft.

In some embodiments, the left-side emergency sub-engine and the right-side emergency sub-engine produce different values of thrust force, thereby providing at least some yaw moment to the aircraft to control a yaw angle of the aircraft. In some embodiments, the one or more control is coupled to a throttle and/or a collective of the aircraft.

There is provided, in accordance some embodiment, a helicopter comprising a frame and one or more main engine integrated with the frame. The helicopter comprises one or more rotor coupled to the main engine(s), thereby allowing the main engine(s) to provide power to the rotor(s). The helicopter comprises an emergency engine coupled to the frame, for providing a forward thrust to the frame when the emergency engine is activated. The helicopter comprises a user interface for receiving input from a pilot of the helicopter, the user interface comprising at least one user control for activating the emergency engine when the main engine(s) stops providing power to the rotor(s), thereby the enhancing autorotation performance of said helicopter.

In some embodiments, the enhancing may be by increasing a flight range of the helicopter, increasing a flight time of the helicopter, decreasing a rate of descent of the helicopter, and/or increasing an airspeed of the helicopter.

There is provided, in accordance some embodiment, a method for facilitating a safe landing of a rotary-wing aircraft in emergency events. The method comprises an action of receiving a request for emergency thrust from a user interface. The method comprises an action of sending a start command to an emergency engine coupled to a rotary-wing aircraft following the request. The method comprises an action of thrusting the rotary-wing aircraft coupled to the emergency engine in a direction substantially of a longitudinal axis of the rotary-wing aircraft, thereby increasing a forward velocity of the rotary-wing aircraft, decreasing the rate of descent, and/or facilitating a safe landing of the rotary-wing aircraft in an emergency event.

In some embodiments, the facilitating may be by increasing a flight range of the rotary-wing aircraft, increasing a flight time of the rotary-wing aircraft, decreasing a rate of descent of the rotary-wing aircraft, and/or increasing an airspeed of the rotary-wing aircraft.

In some embodiments, the emergency event is a main engine failure, a vortex ring state, a tail rotor failure, and a loss of tail-rotor effectiveness (LTE).

In addition to the exemplary aspects and embodiments described above, further aspects and embodiments will become apparent by reference to the figures and by study of the following detailed description.

### BRIEF DESCRIPTION OF THE FIGURES

Exemplary embodiments are illustrated in referenced figures. Dimensions of components and features shown in the figures are generally chosen for convenience and clarity of presentation and are not necessarily shown to scale. The figures are listed below.

FIG. 1 shows a schematic illustration of reference axes and rotations of an aircraft;

FIG. 2 shows a flowchart of a method for enhancing autorotation state of flight, according to embodiments of the invention;

FIG. 3A shows a schematic illustration of an emergency engine system attached to an aircraft for enhancing autorotation state of flight, according to embodiments of the invention;

FIG. 3B shows a second schematic illustration of the aircraft of FIG. 3A with an emergency engine attached for enhancing autorotation state of flight, according to embodiments of the invention;

FIG. 4 shows a schematic illustration of an emergency engine for enhancing autorotation state of flight, according to embodiments of the invention;

FIG. 5 shows a schematic illustration of an emergency engine attached in a first configuration to an aircraft for enhancing autorotation state of flight, according to embodiments of the invention;

FIG. 6 shows a schematic illustration of an emergency engine attached in a second configuration to an aircraft for enhancing autorotation state of flight, according to embodiments of the invention;

FIG. 7 shows a schematic illustration of an emergency engine attached in a third configuration to an aircraft for enhancing autorotation state of flight, according to embodiments of the invention;

FIG. 8 shows a schematic illustration of an emergency engine attached in a fourth configuration to an aircraft for enhancing autorotation state of flight, according to embodiments of the invention;

FIG. 9 shows a schematic illustration of pulse width modulation of an emergency engine for enhancing autorotation state of flight, according to embodiments of the invention;

FIG. 10 shows a schematic illustration of varying duty cycle pulse width modulation of an emergency engine for enhancing autorotation state of flight, according to embodiments of the invention;

FIG. 11 shows a graph of safe altitude versus speed for a helicopter, according to embodiments of the invention; and

FIG. 12 shows a schematic illustration of a helicopter performing a safe landing using an emergency rocket engine, according to embodiments of the invention.

### DETAILED DESCRIPTION

Disclosed herein are embodiments of emergency thrusters for enhancing autorotation flight mode (AFM) of helicopter, rotary-wing aircraft, and/or the like. For example, emergency thrusters are used for improving the chance of safe autorotation landing, extending the range for safe landing during autorotation flight mode (AFM) of helicopters, rotary-wing aircraft, and the like.

In many cases, aircraft emergency events are a result of a main-engine failure. In such a case, the forward thrust provided by an emergency engine, such as a rocket engine, provides energy to maintain the rotation of the main rotor and thus maintains the helicopter lift and assists autorotation without losing substantial altitude. For example, the United States (USA) Federal Aviation Administration (FAA) Helicopter Flying Handbook No. FAA-H-8083-21A, published by the United States Department of Transportation, Federal Aviation Administration, Airman Testing Standards Branch, AFS-630, P.O. Box 25082, Oklahoma City, Okla., USA, and incorporated herein in its entirety by reference, describes in chapter 11 an autorotation state of flight for a helicopter. For example, when the rocket engine is operational, the AFM of a helicopter is similar to the normal mode of an auto-gyro, where the thrust is used to balance the drag of the aircraft, such as fuselage drag, rotor drag, and the like.

As used herein the terms rocket, rocket engine, emergency rocket engine, rocket thruster engine, and the like mean a rocket engine using a propellant to provide thrust to an aircraft in emergency events to enhance the performance of an autorotation state of flight, such as enhance autorotation performance, specifically in rotary-wing aircraft such as helicopters and the like.

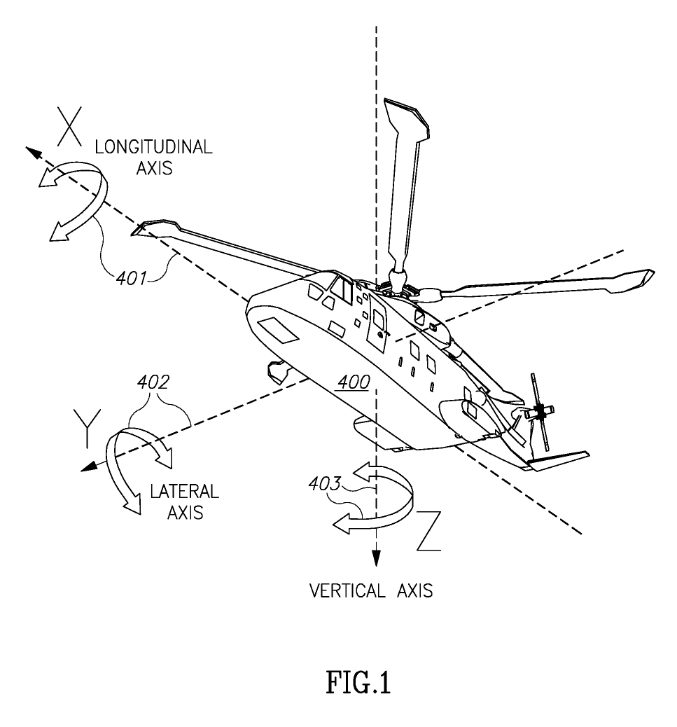

Reference is now made to FIG. 1, which is a schematic illustration of reference axes and rotations of an aircraft 400. An aircraft 400 may have a longitudinal axis 401 in the forward flight direction, which defines the axis of rotation for a roll of the aircraft. A lateral axis defines the axis of rotation for a change in pitch 402. The autorotation state of flight may be entered when the main rotor is unpowered and pitch 402 of aircraft 400 may be raised so that longitudinal axis 401 may be raised nose up and the forward direction produces air flow through the rotor from the bottom side. Vertical axis 403 defines an axis of rotation for a yaw of the aircraft.

A tail-rotor failure may result in a spin of the helicopter due to the lack of tail-rotor thrust moment which balances and/or compensates the main rotor torque. A forward velocity in this case may compensate for this unwanted spin due to the aerodynamic forces that are acting mainly on the helicopter vertical stabilizer and body. Thus a rocket emergency engine thruster may increase the forward velocity, elevation, flight duration, and/or the like, thus increasing the aerodynamic stabilizing forces and decreasing the unwanted spin, such as when a tail-rotor failure occurs during hover or a low-speed maneuver. For example, by automatic activation of the thrusting rocket.

Many existing rocket engines are both dangerous to operate on or near aircraft, cannot be controlled, are too heavy, and/or too bulky to be used as emergency engines.

According to embodiments of the present invention, there are provided methods, devices, assemblies and systems to increase the time and/or flight range of an aircraft when the aircraft does not have sufficient speed and altitude to land safely, for example, when in an autorotation state of flight.

A forward thrust emergency engine, according to present embodiments, provides increased safe landing range, such as time, range, distance, and the like, when autorotation needs to be performed, thus increasing the chances of a successful and safe autorotation and landing. For example, while maintaining the rotor rotational speed within the required limits. For example, a forward pushing emergency rocket engine has the potential to maintain forward velocity in cases of main engine failure and allow controlled forward autorotation flight while maintaining altitude, thus allowing additional flight duration, extending the range for emergency landing, which may be needed in some cases for locating a safe landing location.

Optionally, the emergency engine is a gel-propelled rocket engine coupled to a rotary-wing aircraft, such as a helicopter.

For example, when a helicopter loses main engine power over terrain that does not allow a safe landing, such as over a forest, enemy territory, rocky terrain, mountains, a lake, an ocean, and the like, with the airspeed and altitude available to the aircraft at time of failure, an emergency rocket engine provides increased range under autorotation state of flight of the helicopter to find a safe landing location.

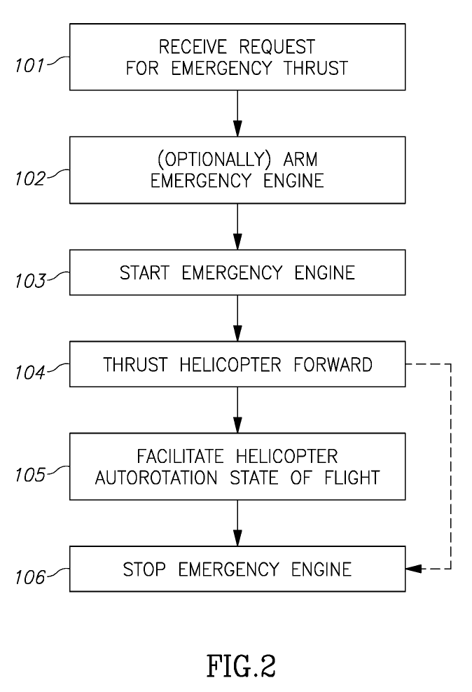

Reference is now made to FIG. 2, which is a flowchart of a method for enhancing autorotation state of flight, according to embodiments of the invention. A method may include an action to receive 101 a request for emergency thrust, such as from a pilot of a rotary-wing aircraft whose main engine has failed. For example, an emergency engine system for providing thrust comprises a user interface in the cockpit for receiving request 101 from the pilot and an emergency thrust start 103 command may be sent from the user interface to an emergency thrust engine coupled to the aircraft, such as coupled to the aircraft fuselage, frame, tail, and the like.

As used herein, the term emergency engine system means a system for supplying forward thrust to an aircraft in an emergency event, such as a main engine failure, and includes components such as a user interface, user controls, an engine, engine components, propellant tanks, propellant tanks, pumps, pressure tanks, valves, tubing, regulators, controllers, combustion chambers, nozzles, and/or the like. As used herein, the term emergency engine means an engine capable of supplying thrust to an aircraft once activated, and the engine components may be grouped into sub-systems, assemblies, and the like, comprising one or more components in each assembly. As used herein the term sub-system means a group of system components that can be controlled externally and operate as a unit. As used herein the term assembly means a group of system components that are integrated together but cannot function as an independent unit to perform one or more function of the system.

Optionally, the start 103 command is preceded by an arm 102 command sent to the emergency engine system, such as a manual arm command, an automatic arm command, a semi-automatic arm command, and the like.

The start engine command from the user interface activates the thrust 104 of the emergency engine which may be applied to the fuselage, frame, a fixed point of the aircraft mechanical structure, and/or the like of the aircraft, by a coupling mechanical element between the emergency engine and the aircraft frame. As used herein, the term frame means any parts of an aircraft that can accept forces and apply them to the aircraft as a whole, such as the fuselage, frame, mechanical framework, tail, structural support elements, and the like. For example, emergency engine thrusts 104 forward a helicopter coupled to the emergency engine. The forward thrust of the aircraft may allow the aircraft pilot, such as a helicopter pilot, to raise the pitch of the aircraft, and thus the thrust improves 105 the performance of an autorotation state of flight to the aircraft. The emergency engine may be stopped 106 either before or after the AFM has started.

Optionally, the emergency engine is started 103 and the aircraft is thrust 104 forward for a limited amount of time. For example, the aircraft is thrust forward for 10 seconds. For example, the aircraft is thrust forward for more than one second and less than ten minutes, optionally in one or more intermittent bursts. For example, AFM state of flight is initiated at 2000 feet AGL over a forest and the emergency engine is activated between five and 30 seconds to provide a longer distance to find a safe landing. A second operation of the emergency engine may be performed at an altitude of 325 feet to provide an additional distance of 100 feet in the forward direction to reach an identified safe landing location. For example, operation of the emergency engine is initiated when the aircraft is in VRS at 325 feet altitude and thus the forward velocity is used to evade the VRS condition without the need to lose altitude by pitching down.

Optionally, forward thrust 104 may be controlled, either by modulation (i.e. PWM) or by reduction/increase of continuous thrust. For example, thrust 104 may be effectively lowered, i.e. modulated to avoid structural damage to the aircraft. For example, the thrust may be increased by certain modulation or by decreasing propellant mass flow rate to improve maneuverability of the aircraft, for example to avoid a collision with a second aircraft. For example, the thrust is modulated to avoid heating of aircraft components due to the heat transfer from emergency engine exhaust gases.

Optionally, the emergency engine exhaust gases may be directed laterally to provide sideways thrust to control aircraft yaw, such as to compensate for tail rotor failure, ineffectiveness, and/or the like. For example, the emergency engine may have a moveable nozzle and/or deflector for providing lateral thrust to the aircraft thus allowing a change in yaw of the aircraft. For example, the change in yaw may be required to correct for a tail rotor failure, a Fenestron™ failure, a failure in one rotor of a dual rotor aircraft, a ducted fan tail rotor ineffectiveness, and the like. For example, a controller uses a gyroscopic sensor and a dedicated control algorithm to stabilize the yaw of an aircraft in an emergency event, such as a tail rotor failure and the like.

Optionally, the emergency engine thrust is angled so as to have a neutral effect on the aircraft pitch. For example, the emergency engine is angled so that the exhaust gases are directed upwards or downwards relative to the longitudinal axis of the aircraft at a 5, 7.5, 10, 15, 20, 25, or 30-degree angle, or any other angle in between, so as to neutralize the effect of the thrust of the emergency engine on the aircraft's pitch angle. For example, the emergency engine is angled so that the exhaust gases are directed upwards or downwards relative to the longitudinal axis of the aircraft at an angle between −10 and +10 degrees. For example, the emergency engine is angled so that the exhaust gases are directed upwards or downwards relative to the longitudinal axis of the aircraft at an angle between 1 and 35 degrees. For example, the emergency engine is angled so that the thrust provided to the aircraft is aligned near the center of mass of the aircraft so as to avoid destabilizing the aircraft pitch angle.

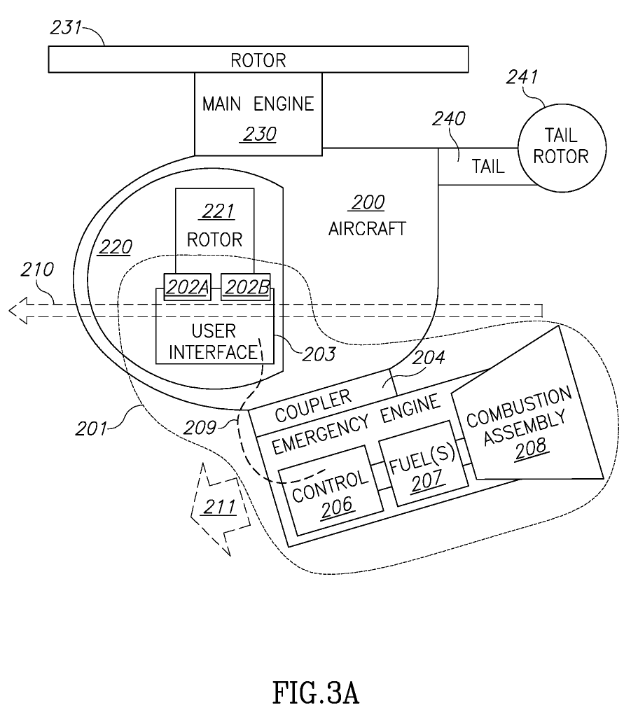

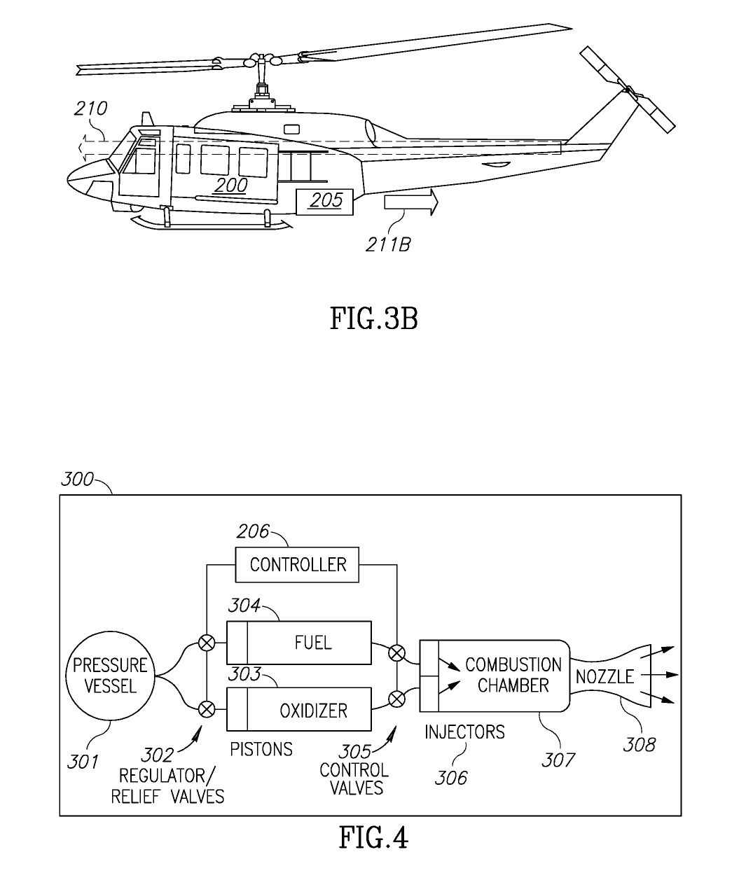

Reference is now made to FIG. 3A, which shows an emergency engine system 201 attached to an aircraft 200 for enhancing autorotation state of flight, according to embodiments of the invention. Emergency engine system 201 comprises a user interface 203, optionally installed in a cockpit 220 of rotary wing aircraft 200. User interface 203 comprises one or more user controls, such as 202A, 202B, and the like, for receiving user input (101 in FIG. 2), such as an emergency thrust request, from a pilot 221 of aircraft 200. User interface 203 may optionally incorporate electronics to convert the operation of the user controls to a medium suitable for transfer by communication interface 209 to controller 206 of an emergency engine 205. For example, user interface 203 electronics converts the action of a button 202A to an electronic signal, a digital signal, an analog signal, an electromagnetic signal, a fiber optic signal, a wireless signal, and/or the like. Emergency engine 205 comprises controller 206, such as a control unit and the like, one or more propellants containers 207, such as containers for fuels, oxidants, and the like, and combustion chamber assembly 208 where the propellants are converted to forward thrust 211 of emergency engine 205. A coupler 204, such as a coupling unit and the like, transfers the force produced by emergency engine thrust 211 to aircraft 200, such as transferred to the fuselage, frame, and the like of aircraft 200, thereby providing at least some of emergency engine thrust 211 as forward thrust (104 in FIG. 2) to aircraft 200 along longitudinal axis 210.

Optionally, emergency engine 205 is coupled to tail 240 of aircraft 200.

When a main rotor 231 of aircraft 200 stops receiving power from main engine 230, or when tail rotor 241 fails, or the like, pilot 221 may press an arming button 202A to arm (102 in FIG. 2) emergency engine 205, and pilot 221 may start (103 in FIG. 2) and/or modulate the emergency thrust by selectively activating an emergency thrust level control 202B. For example, a main engine 230 failure causes a freewheel system to allow main rotor 231 to rotate freely. Optionally, the emergency thrust is provided automatically by pilot 221 pressing arming button 202A which also starts (103 in FIG. 2) emergency engine 205 combustion. When emergency engine 205 thrust 211 is initiated, controller 206 provides propellant(s) 207 to combustion chamber assembly 208, such as by selectively opening valves, and the propellant may be ignited in combustion chamber assembly 208 to produce thrust 211. Forward thrust (104 in FIG. 2) acting on aircraft 200 increases the aircraft safe landing distance, and pilot 221 may raise the pitch of the aircraft thereby enhancing (105 in FIG. 2) an autorotation state of flight, such as without losing substantial altitude.

Optionally, when tail rotor 241 of aircraft 200 malfunctions pilot 221 may operate emergency engine 205 to provide thrust 210 to the aircraft and subsequently enhancing (105 in FIG. 2) an autorotation state of flight and compensating for the malfunction. As used herein, the phrases enhancing the autorotation flight performance, enhancing autorotation, and enhancing an autorotation state of flight may all refer to the improved flight performance during and autorotation stat of flight.

Optionally, emergency engine 205 is a rocket engine, such as a solid rocket engine, a liquid propellant rocket engine, a gas propellant rocket engine, a gel propellant rocket engine, a hybrid rocket engine, a monopropellant rocket engine, a bipropellant rocket engine, a tri-propellant rocket engine, and/or the like. For example, the hybrid rocket engine comprises any combination of gas, liquid, solid, semi-solid (gel), and the like propellants. For example, a bipropellant rocket fuel is a propellant with two components. Optionally, the propellant(s) of an emergency rocket engine 205 include one or more of liquid oxygen, liquid hydrogen, kerosene, nitrogen tetroxide, hydrazine, unsymmetrical dimethyl hydrazine, and/or the like. Optionally, the propellant(s) of an emergency rocket engine 205 are solid propellants, liquid propellants, gel propellants, and/or hybrid propellants comprising any combination of solid, liquid or gel propellants. Optionally, the propellant(s) of an emergency rocket engine 205 are any combination of monopropellants, bipropellants, tri-propellants, and/or the like. Optionally, the propellant(s) of an emergency rocket engine 205 are hypergolic propellant(s). In embodiments of the invention, an emergency rocket engine may use any combinations of propellant types suitable for the specific type of rocket engine, and these combinations are not limited to or reflect on the acceptability, toxicity, practicality, profitability, and/or like considerations of emergency engine 205.

Reference is now made to FIG. 3B, which is a second schematic illustration of the aircraft of FIG. 3A with an emergency engine attached for enhancing autorotation state of flight, according to embodiments of the invention. As in FIG. 3A, emergency engine 205 may be coupled to aircraft 200, so that when emergency engine 205 is activated, the propellant combustion causes the exhaust gases to leave the engine nozzle backwards 211B producing a forward thrust (211 in FIG. 3A) on coupler (204 in FIG. 3A) thereby thrusting aircraft 200 forward 210.

Following are described several specific considerations and options for different embodiments of the invention.

Reference is now made to FIG. 4, which is a schematic illustration of an emergency rocket engine 300 for enhancing autorotation state of flight, according to embodiments of the invention. Similar components of an emergency engine previously described in FIG. 3A and FIG. 3B may use the same reference numbers. Included in emergency rocket engine 300 may be a feeding system that may include propellant storage tanks as at 303 and 304, a controller 206, a pressurization system, such as a pressure vessel 301 for driving the propellants from the tanks towards combustion chamber 307, valves 302 and 305 for the regulation of the propellant flow, tubing from the tanks towards combustion chamber 307 and/or injector 306, and the like. Optionally, pumps may be included in the pressurization system.

Rocket engine 300 may combine injectors 306, combustion chamber 307, and nozzle 308 to form a single sub-system, such as an Emergency Engine Combustion Assembly, in order to optimize the combustion process and the flow of the exhaust gases. Optionally, the propellant and/or feeding system components may be located separately from the engine combustion assembly in accordance with specific aircraft and/or engine limitations. Separately locating some engine components may be done as long as the propellant flow to combustion chamber assembly 208 may be provided by the pressurization system and/or an alternative power cycle. This kind of modular system design allows significant flexibility for the installation and adaptation of emergency rocket engine 205 on an aircraft. Other considerations in choosing a modular or unified engine design approach, may be system cost, maintainability, and simplicity of installation. Each type of engine design may have advantages and disadvantages for specific installations, depending on the specific aircraft application and design features. For example, higher pressure and/or larger capacity of pressure vessels may be needed to guarantee the propellant flow, with increased distance from the combustion chamber to the propellant tanks or the pressure vessels.

A Gel Rocket Engine (GRE) may often be defined as a rocket engine in which the propellants, such as a fuel, and oxidizer and/or the like, are stored in a gel state in their respected tanks before injection into the combustion chamber. A rocket engine in which either the fuel or the oxidizer are liquids may be considered a GRE when one or more propellant is stored in a gel state.

A GRE system may be similar to a Liquid Rocket Engine (LRE) system with relevant modifications and adaptations due to the special mechanical nature of the gel. It includes the engine itself, which may comprise a combustion chamber, a nozzle, an injector, a feeding system for the propellant components, a control system, an ignition system, and the like, and may have other auxiliary units such as cooling system components and safety systems. Like in a LRE, a GRE may be turned on and off by means of controlling the flow of propellant components.

Liquid bipropellant rocket engines, as well as GREs, may be categorized according to their power cycles, such as how power is derived to feed propellants to the main combustion chamber. Complex feeding systems, usually seen on large rockets, may be based on pumps that feed the propellant. For example, high-mass flowrate systems use specialized pumps, also known as turbo-pumps, that are driven by a gas generator which may be fed by the engine's own propellant. In a pressure-based propellant feed system, the system does not use pumps or turbines and instead relies on tank pressure, electrically induced piston pressure, or the like, to feed the propellants into the combustion chamber. In practice, the pressure-based feed system may be limited to relatively low chamber pressures because higher pressures make the chambers too heavy. The pressure-based feed system may be reliable, given its reduced part count and complexity compared with other systems. Optionally, a pressure-fed GRE based on a hypergolic composition, for example with no ignition system, is used as emergency engine.

In pressure-based feed systems, chamber pressures may range from 7 to 250 atmospheres. However, typical pressure values may be 20-80 atmospheres for combustion chamber assembly 208 and 20-40 atmospheres higher for the feeding pressure. These pressure values may change for a specific rocket engine based on the specifications.

Following are installation limitations and considerations of emergency rocket engine on an aircraft.

Location of an emergency rocket engine, and specifically the emergency engine assembly, may be determined by the engine thrust vector and exhaust gases path. The location of the GRE components may be such that the functionality of the emergency rocket engine is provided while the aircraft integrity and safety is maintained. For example, in an emergency rocket engine application for providing thrust to helicopters, one such consideration may be that the thrust vector coincides, as much as possible with the helicopter's center of gravity and directed along the helicopter longitudinal axis. Such a configuration may avoid or minimize further manipulation of the helicopter controls when the emergency thrust engine is activated and avoid inducing a rotational movement of the helicopter as a byproduct of the forward thrust vector. For example, a rotor-wing aircraft may have a minimum rate of descent of 1500 feet per minute at an airspeed of 60 knots, during AFM. For example, a rotor-wing aircraft may have a maximum safe landing distance at a rate of descent of 1800 feet per minute at an airspeed of 85 knots. For example, a rotary-wing aircraft is flying below an autorotation airspeed, and the emergency rocket provides forward thrust to enhance an autorotation state of flight. For example, a rotary-wing aircraft has an engine failure, a freewheeling unit failure, and/or the like, and the emergency rocket provides forward thrust to enhance an autorotation state of flight by increasing the flight distance and/or time to a safe landing location while maintaining autorotation state of flight.

Optionally, a safety consideration is the exhaust gas path from the emergency engine. Optionally, the cone-shaped path exhaust path does not intersect any aircraft structural parts, or that the effect of the exhaust gases does not result in an immediate adverse implication to the aircraft, such as structural disengagement, fire, and the like. For example, installation in a helicopter is performed to avoid the helicopter vertical stabilizer assembly which is located at the rear of the helicopter tail.

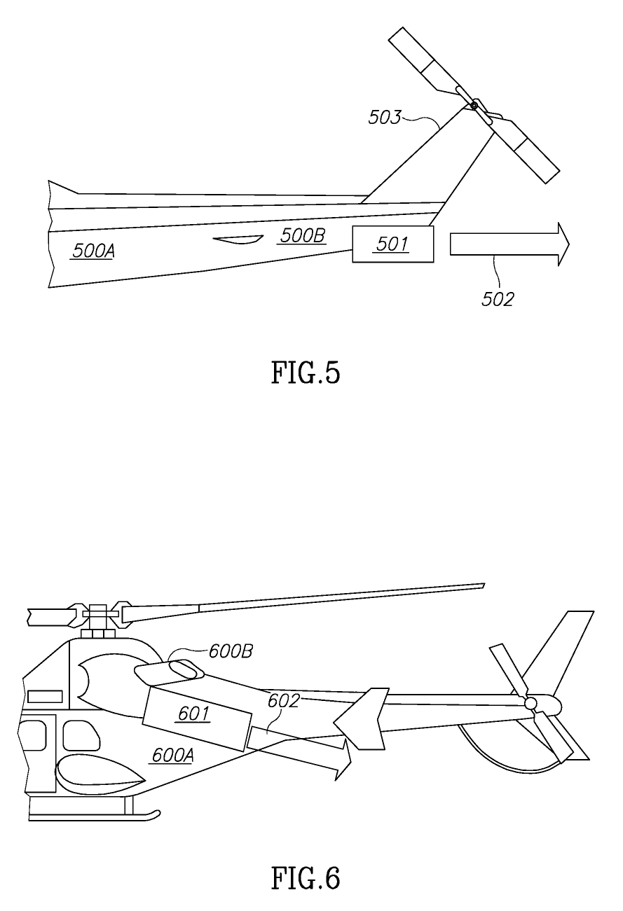

Reference is now made to FIG. 5, which is a schematic illustration of an emergency engine attached in a first configuration to an aircraft 500A for enhancing autorotation state of flight, according to embodiments of the invention. The aircraft 500A has tail 500B, and emergency engine 501 is coupled to tail 500B, below tail rotor 503, so that exhaust gasses 502 of emergency engine 501 are directed behind tail 500B and below tail rotor 503.

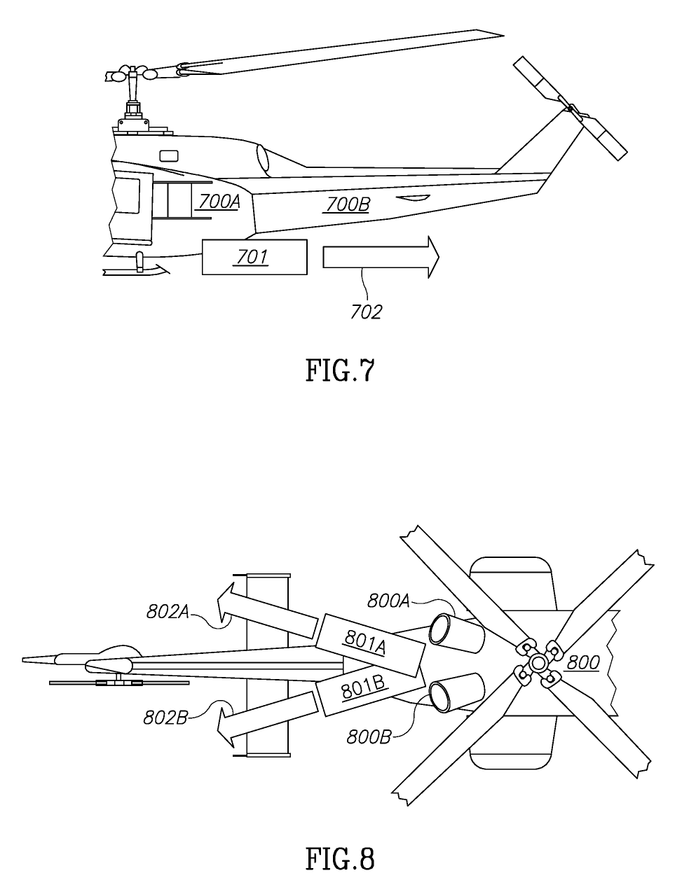

Optionally, specific aircraft have specific locations for an emergency engine. Reference is now made to FIG. 6, which is a schematic illustration of an emergency engine attached in a second configuration to an aircraft 600A for enhancing autorotation state of flight, according to embodiments of the invention. Aircraft 600A has emergency engine 601 coupled to the frame below main engine outlets 600B, so that exhaust gasses 602 of emergency engine 601 are directed, for example downwards, to not interfere with the structural integrity of the frame, tail wings, and/or other components of the aircraft. Reference is now made to FIG. 7, which is a schematic illustration of an emergency engine attached in a third configuration to an aircraft 700A for enhancing autorotation state of flight, according to embodiments of the invention. Aircraft 700A has a tail 700B, and emergency engine 701 is coupled to the frame below the fuselage, so that exhaust gasses 702 of emergency engine 701 are directed below tail 700B.

Optionally, two rocket engines and/or combustion chambers may be used in order to provide symmetric thrust on both sides of the aircraft when a single engine violates safety consideration and/or regulations. Reference is now made to FIG. 8, which is a schematic illustration of an emergency engine attached to a fourth aircraft 800 for enhancing autorotation state of flight, according to embodiments of the invention. Aircraft 800 has two emergency engines 801A and 801B coupled to the frame below main engine outlets 800A and 800B, so that exhaust gasses 802A and 802B of emergency engines 801A and 801B are directed parallel to main engine exhaust and thus do not interfere with the structural integrity of the frame. For example, a dual rocket engine configuration may use a single or dual feeding systems. For example, actual installation and systems design take into consideration a specific helicopter's structure and structural requirements.

Following are considerations for the installation of an emergency rocket engine on an aircraft.

Optionally, regulatory documents are used to determine structural and operational requirements of attaching an emergency engine to an aircraft, such as described in “Acceptable Methods, Techniques, and Practices for Aircraft Alterations” published by the United States Federal Aviation Administration (FAA) in Advisory Circular (AC) No. 43.13-2b incorporated in its entirety by reference and others. For example, AC 43.13-2b, which relates to civil aircraft of 12,500 pounds (or pound-mass, both of which are units of mass as used herein) gross weight or less, refers to the Aircraft Structural Data, and describes the structural design process, determination of types of loads and stresses, materials and workmanship, effects on weight and balance, and the like. For example, aircraft heavier than 12,500 pounds gross weight may use emergency engine for providing forward thrust in emergency events. For example, a Robinson R22 weighs 796 pounds (389 kilograms), an empty Chinook weighs 23,401 pounds (10,185 kilograms), and a Russian Mi-12 weighs 15,200 pounds (6,910 kilograms), and the like.

For example, the effect of the emergency thrust on the helicopter weight and balance is considered at all stages of the propellant burn to comply with the helicopter weight and balance requirements. For example, the propellant tanks 303 and 304 when loaded with the propellants are the heaviest components of the emergency rocket engine and once ignited the propellants are continuously depleted. For example, the emergency engine center-of-mass location coincides with and/or is located close to the aircraft center of mass.

Optionally, propellant tanks are cylindrical when pressurized by integrated pistons. Optionally, different shaped propellant tanks are used when the pressurization system is separate from the tanks, an integrated pressurization unit is incorporated into the tanks, and the like.

Optionally, emergency engine includes a controller, for controlling the operation of emergency engine. As used herein the term controller means a unit, sub-unit, component, and the like, that controls other components of emergency engine and/or emergency engine system, such as an Engine Controller (EC), control unit, programmable controller, computerized controller, programmable logic controller, electronics circuit, and the like. For example, a micro-computer with various inputs and outputs (I/Os) interfaces with the different emergency rocket engine sensors to determine various parameters such as flow rates, temperature levels, pressure levels, pressurization system status, and the like. For example, the EC outputs control the feeding system valves and determine the propellant components mass-flow-rate, the engine thrust, the engine operation duration, and the like.

The control unit may also include its own Independent Power Source (IPS), such as a thermal battery activated by pyrotechnic and/or pyroelectric igniter, for driving the controller itself, the other control units, such as sensors, valves, and the like.

Optionally, the EC utilizes an external power source from the aircraft power. The following examples assume an IPS as a part of emergency rocket engine.

The EC may receive one or more signals from the aircraft avionics system or directly from the pilot through user interface 203, such as an Arm Command Signal (ACS), a Main Command Signal (MCS), and the like. The ACS may have two possible positions, such as an ACS On that clears the way for MCS and the engine regulation and an ACS Off that blocks the MCS and/or other engine operations. The MCS may be based on various flight parameters, aircraft position, altitude, velocity vector, aerodynamic configuration, and the like. The MCS may be processed using a dedicated algorithm-based method performed by a controller, such as described below. For example, a basic control sequence for the operation of a GRE as a back-up or emergency thrust engine on an aircraft or rotorcraft comprises a Regulator Valves (RV) Off and/or Control Valves (CV) Off condition where the GRE is not armed and not activated. For example, a basic control sequence comprises a RVs On and/or CVs Off where the GRE is armed (102 in FIG. 2), such as when high pressure is induced to the propellant tanks pressuring them towards the CVs. Subsequently opening the CV may result in the propellant components injected into the combustion chamber. For example, a basic control sequence comprises a RVs On and/or CVs On, where the GRE thrust is activated. The resulting thrust may be a result of the combustion of the fuel and oxidizer entering the combustion chamber. By changing the On/Off state of the CVs, the operator, such as a pilot, a pre-defined algorithmic sequence performed by a controller, and the like, may control the actual operation of the GRE.

Optionally, a method to control the thrust level is performed by a pre-defined algorithmic sequence performed by a controller, such as Pulse Width Modulation (PWM) sequence, in which a specific thrust level, which is lower than the maximum GRE thrust level, is attained by a cyclic opening and closing operation of an on/off states of CVs.

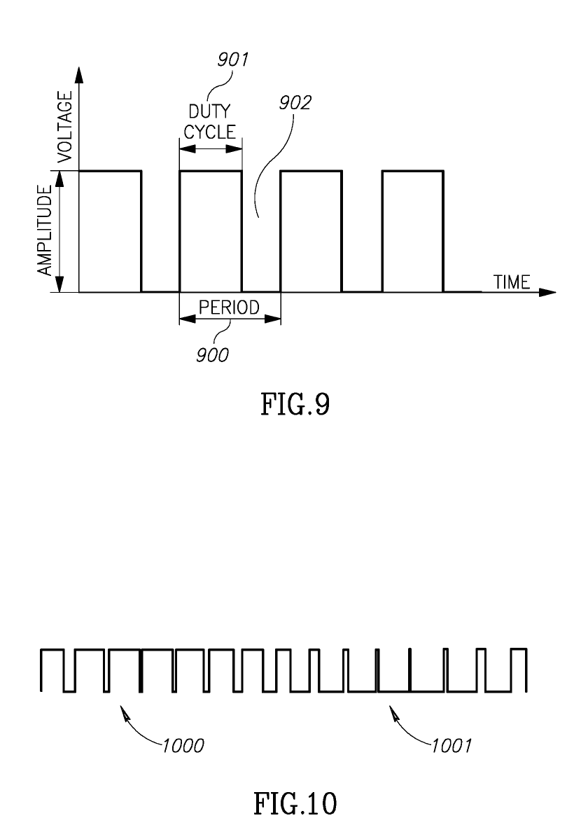

Reference is now made to FIG. 9, which is a schematic illustration of pulse width modulation of an emergency engine for enhancing autorotation state of flight, according to embodiments of the invention. The PWM method changes activation time width, or duty cycle 901, of rocket engine during each pulse period 900. During each pulse period 900 when the rocket engine is not active, the rocket engine may be in off state 902. By changing the relative amount of time between duty cycle 901 and off state 902 for each pulse period 900 the rocket engine may be modulated. In this case, the propellant flow-rate control may be provided by means of varying duty cycle 901, namely, the fraction of time that the valve is open during each period. Reference is now made to FIG. 10, which is a schematic illustration of varying duty cycle pulse width modulation of an emergency engine for enhancing autorotation state of flight, according to embodiments of the invention. As seen at 1000 the time of duty cycle may be high and the time of off state may be low, and the thrust may be high. As seen at 1001 the time of duty cycle may be low and the time of off state may be high during each period (900 of FIG. 9), and the thrust may be low. Examples of such a control sequence are described by Hanan Rom et al., in a publication titled “Thrust control of hydrazine rocket motors by means of pulse width modulation”, published as IAF-89-283 and presented at the 40th Congress of the International Astronautical Federation, Malaga, Spain, 7-13 Oct. 1989, and incorporated herein by reference in its entirety.

Optionally, variants of the basic GRE structure provide similar or equivalent functionality. For example, using separate pressure vessels for the fuel and oxidizer tanks instead of a single pressure vessel, using a single RV instead of two RVs, using a single piston for both propellant tanks, rigidly attaching the two pistons of the propellant tanks, such as to set a fixed Oxidizer to Fuel (0/F) ratio, using diaphragms and/or bladders to pressurize the propellants in the tanks instead of pistons, and the like.

For example, an emergency engine, such as a thrust rocket, is operated in two stages, such as an arming stage and an activating stage for producing thrust. The activating stage cannot be activated without first performing that arming stage. For example, once system is armed, multiple thrust activations are possible, until system is disarmed. For example, the arming stage mechanism of user interface may be located in a different location of activation stage and clear alarming signals or voices may be introduced once system is armed in order to avoid misfire. Such an arming mechanism may be compared to an ejection seat mechanism, ballistic recovery systems, and the like.

Optionally, user interface comprises control for arming the emergency engine. For example, a user input operating arming control arms the emergency engine by priming the pressure system, activating an emergency thermal battery, pressurizing one or more propellant tanks, and the like.

Optional, a user interface comprises a control for activating an emergency engine. For example, a pilot first arms an emergency engine with a first control and then activates an emergency engine with second control.

Optionally, a user interface comprises a modulating control for modulating the thrust provided by the emergency engine. For example, a user interface has a hybrid control comprising a rotating lever, and the pilot presses the lever to arm the emergency engine and then rotates the lever to modulate the emergency engine thrust.

The arming stage functionality may provide pressure to the propellant tank's pressurization system. Deploying such pressure to the system minimizes the time for the actual activation of the rocket engine and may provide necessary indication to the operator in case the system has a malfunction. Such deployment may be risky in terms of possible misfire and in case of a crash or other accident when the system might need to be de-pressurized for safety considerations. Optionally, a locking pin is used to disable emergency engine when aircraft not in flight, such as a remove before flight pin and the like.

Once activated, a selected thermal battery may reach its activation voltage in less than a second. The pressure rise in the pressurization systems may be measured in milliseconds and the total time for arming the system from a received pilot input, may be adjusted to be less than a second which may enable forward thrust after very little loss of altitude, such as 3 meter or less.

When the arming function does not provide pressure to propellant tanks, the arming function may be pure logical, with or without the actual activation of the thermal battery, such as by electronic gating the further activation of the rocket engine. Optionally, other means, such as mechanical gating, may allow further activation of the rocket engine.

Arming of the rocket engine, which may be either a predefined step in the operation of emergency rocket engine or a part of the activation sequence, may be confirmed by both pilot and/or operator action, and optionally confirmed by a machine algorithm performed by a controller.

The arming decision by the pilot and/or operator should be clearly defined in the aircraft manuals and be based on the pilot and/or operator recognition that an emergency event has occurred which may require the activation of the emergency rocket. Such indications include engine failure (indicated by an automated alarm, decrease in engine and/or rotor RPM, or by feel), tail-rotor failure, operation of the helicopter with insufficient altitude and/or speed (for example, when the helicopter encounters wake turbulence), and the like.

Depending on available helicopter sensors and avionics, including other aircraft parameters, such as altitude, airspeed, attitude, climb rate, and the like, may be used for determining the need of an emergency thrust rocket engine operation. Other environmental conditions, such as actual geographical location, day/night time, and the like, may also serve such as input parameters to a control algorithm based method performed by a controller. For example, certain locations, such as highly populated areas, may prohibit the use of rocket engines at a low altitude or for even any other reason.

The pilot may also receive some indications or system recommendations for activating the rocket engine. For example, inputs received from other alarm and/or warning systems on the aircraft, such as helicopter engines indicators and Helicopter Terrain Awareness and Warning System (H-TAWS), may recommend using the emergency engine. For example, H-TAWS system gives a pilot advanced warning about hazardous terrain and obstacles along their flight path and altitude.

An emergency thrust rocket may be activated by a human pilot, an automatic algorithm-based control method performed by a controller, a combination of both, and the like. For example, when an engine failure occurs, the rotor rotation speed starts to decrease, and the like, the collective may be lowered manually and/or automatically. Next, the emergency rocket engine may fire manually or automatically, and the pilot operates the cyclic to maintain flight speed in AFM, optionally using pedals to control yaw, optionally using an automatic pilot, while collective may be used to maintain rotor rotation speed. Landing may be performed by standard flair when the aircraft is near ground level, by raising the nose to stop forward speed and using the remaining energy in the rotating rotor to soften the touch down.

Optionally, the user controls of an emergency engine are located on or near a cockpit control of the aircraft, such as the collective, cyclic, pedal, throttle, and the like. For example, the pilot turns the rocket on or off using a control, such as a button, a switch, a handle, a grip, and the like, which may be any means physically located on the collective but have no logical interface to the collective movement or location. For example, operation of a thrust rocket emergency engine may include some kind of coupling of the rocket on/off function with the cyclic control position, a collective position, and/or the like.

For example, the pilot's rocket control includes a logical interface between the rocket activation and the throttle position, thus providing a throttling of the rocket engine. Various thrust levels may be provided by several means such as by controlling the propellant flow rate or by PWM as described herein.

For example, the emergency rocket activation control is separately located in the cockpit from the collective, such as a hand activation, a leg activation, a second pilot activation, and the like.

For example, an operation of an emergency rocket engine to provide a back-up for the failure of the tail rotor may be coupled to the helicopter anti-torque pedals, rather than the cyclic, throttle, or collective.

Optionally, automatic activation of the emergency engine is performed after the system is armed and may be based on pre-defined algorithm-based methods performed by a controller. For example, emergency activation may depend on available helicopter sensors and avionics and/or emergency engine system sensors, such as altitude, airspeed, attitude, climb, and the like. For example, sensor values are used for determining the need of an emergency thrust rocket engine operation. Optionally, other environmental conditions such as geographical location, time of day, and the like, may be used for controlling activation of an emergency engine, such as operation in highly populated areas, in flammable/explosive environments, and the like. For example, a location sensor value is used to prevent activation of an emergency rocket engine where it may not be allowed. The emergency rocket engine thrust level and impulse time may be determined by a closed-loop control sequence that measures the flight parameters and the aircraft position in order to determine the thrust that may be needed.

Optionally, combinations of the herein described control methods may be utilized in embodiments of the invention. For example, a combined activation is based on automatic activation of the rocket engines with manual control stop the engine by the pilot.

For example, a Bell 204B® helicopter equipped with a gel-propelled emergency rocket engine is flying at an altitude of 500 feet and an airspeed of 15 knots. The emergency engine is coupled to the fuselage underneath the helicopter tail as in FIG. 7. A main engine failure occurs, the main rotors stop receiving power, the pilot recognizes the situation and lowers the collective to the minimum, and the rotor starts freewheeling—beginning AFM. The pilot immediately arms and activates the emergency engine, increasing the airspeed to 60 knots as the helicopter descends to 400 feet. When the emergency engine is active and airspeed increases, the pilot might choose to slightly and gradually increase the pitch angle of the aircraft. When safely in AFM, and upon reaching the ground towards landing, the pilot performs a “flare”, raising the pitch angle of the aircraft to reduce airspeed, and lands the helicopter safely.

For example, a twin main engine Bell 206LT TwinRanger® helicopter is equipped with two gel-propelled emergency rocket engine coupled to either side of the helicopter near the main engine exhausts, as in FIG. 8. The helicopter is flying at an altitude of 400 feet and an airspeed of 10 knots. A main engine failure occurs, the main rotors stop receiving power, the pilot recognizes the situation and lowers the collective to the minimum, and the rotor starts freewheeling—beginning AFM. The control unit of the emergency engine immediately identifies the emergency event and automatically arms the emergency engine. The pilot immediately activates the emergency engine, increasing the airspeed to 60 knots as the helicopter descends to 325 feet. When the emergency engine is active and airspeed increases, the pilot might choose to slightly and gradually increase the pitch of the aircraft. When safely in AFM, and upon reaching the ground towards landing, the pilot performs a “flare”, raising the pitch angle of the aircraft, and lands the helicopter safely.

For example, an AgustaWestland® AW-139 is equipped with two gel-propelled emergency rocket engine coupled to either side of the helicopter near the main engine exhausts, as in FIG. 6. The helicopter is flying at an altitude of 800 feet and an airspeed of 0 knots (i.e. hover). A main engine failure occurs, the main rotors stop receiving power, the pilot recognizes the situation and lowers the collective to the minimum, and the rotor starts freewheeling—beginning AFM. The control unit of the emergency engine immediately identifies the emergency event and automatically arms and activates the emergency engine, increasing the airspeed to 60 knots as the helicopter descends to 600 feet. When the emergency engine is active and airspeed increases, the pilot might choose to slightly and gradually increase the pitch of the aircraft. When safely in AFM, and upon reaching the ground towards landing, the pilot performs a “flare”, raising the pitch of the aircraft, and lands the helicopter safely.

For example, an Enstrom® 480B helicopter weighing 2,600 pounds is equipped with a gel-propelled emergency rocket engine and is flying at an altitude of 1000 feet and an airspeed of 60 knots. The emergency engine is coupled to the fuselage underneath the helicopter tail as in FIG. 7. A main engine failure occurs, the main rotors stop receiving power, the pilot recognizes the situation and lowers the collective to the minimum, and the rotor starts freewheeling—beginning AFM. The pilot immediately arms and activates the emergency engine to provide a thrust of 350 kilograms force to preserve horizontal flight and increasing the flight range. When reaching the ground towards landing, the pilot performs a “flare”, raising the pitch of the aircraft, and landing the helicopter safely.

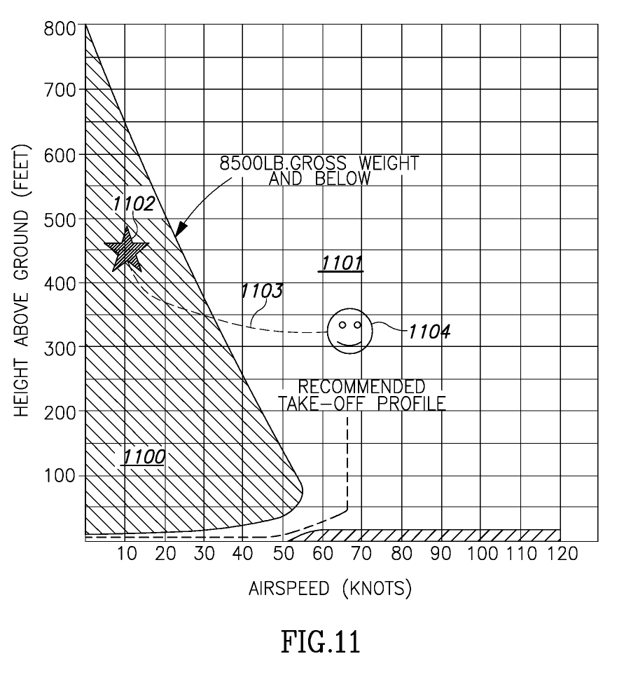

Reference is now made to FIG. 11, which is a graph of safe altitude versus speed for a helicopter, according to embodiments of the invention. The graph shows two main height and airspeed regions, the first 1101 where safe aircraft fight may be performed, and in case of a main engine failure the aircraft may most likely land safely using AFM, and the second region 1100 may be where the aircraft may not be able to land safely. When a main engine failure occurs when the aircraft parameters are in the second region 1100 (patterned with diagonal lines), such as at altitude and speed marked by the star icon 1102, the emergency engine may thrust the aircraft forward, thus increasing 1103 the velocity as the aircraft descends, and the aircraft parameters enter the first region 1101 as at 1104.

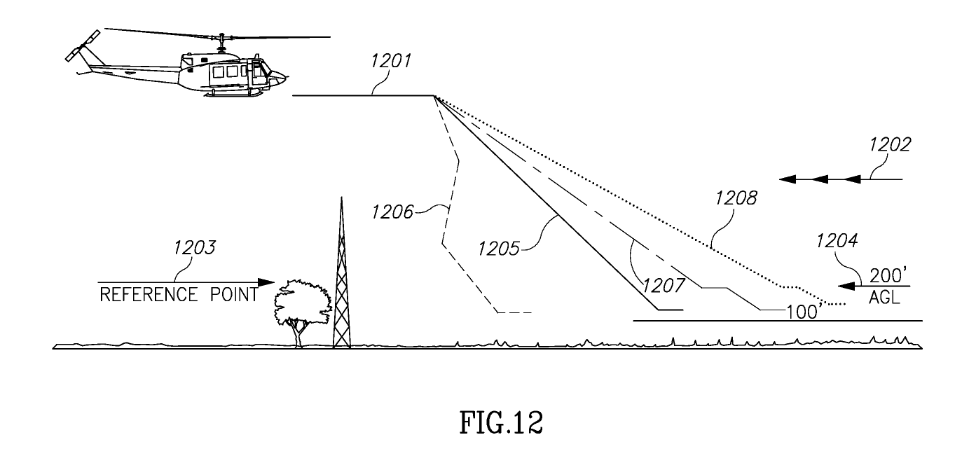

Reference is now made to FIG. 12, which is a schematic illustration of a helicopter 1201 performing a safe landing using an emergency rocket engine, according to embodiments of the invention. In this example, a helicopter traveling along a flight path 1201 has a main engine failure at an altitude of 1000 feet above ground level (AGL), such as above reference point 1203. The failure occurred while at a speed of 80 knots airspeed while headed into a headwind 1204 of 25 knots. The pilot enters AFM and may have to choose between a maximum distance emergency landing 1205 or a minimum descent rate emergency landing 1206. The pilot chooses to operate the emergency engine after entering AFM to allow a longer distance to a safe landing1208 or more time to a safe landing 1207, and the emergency engine thrust may be modulated by the pilot to allow a stable AFM flight of the helicopter while being thrusted.

Following are some numerical examples of an emergency rocket engine of a helicopter. For example, a 30-kilogram emergency rocket engine provides 600 kilograms of force thrust for 10 seconds from 20 kilograms of propellant. For example, a 50-kilogram emergency rocket engine provides 600 kilograms of force thrust for 20 seconds from 40 kilograms of propellant. For example, a 30-kilogram emergency rocket engine is coupled to a Bell® model 206® helicopter weighing 1400 kilograms (gross weight). The emergency rocket engine provides 280 kilograms of thrust for 20 seconds at 0.9 kilogram per second propellant consumption rate, increasing the distance to a safe landing by 500 meters. For example, a 15-kilogram emergency rocket engine is coupled to a Robinson® model 22 helicopter weighing 600 kilograms (gross weight). The emergency rocket engine provides 120 kilograms of thrust for 20 seconds at 0.4 kilogram per second propellant consumption rate, increasing the distance to a safe landing by 500 meters.

Optionally, a remote pilot of a rotary-wing unmanned aerial vehicles (UAVs) uses an emergency rocket engine to extend the range of landing, such as time, distance, altitude, and the like, when a main engine fails. For example, an emergency rocket engine operated by a remote pilot when coupled to a rotary-wing AUV that has a main engine failure, provides increased situation awareness to a remote pilot by providing more time, distance, altitude, and the like to perform a safe landing. Some benefits of a gel-propelled emergency rocket engine are the ability to achieve a stable, safe, controllable, and compact design for the emergency engine, thereby allowing the emergency engine to comply with practical and regulatory requirements.

In the description and claims of the application, each of the words “comprise” “include” and “have”, and forms thereof, are not necessarily limited to members in a list with which the words may be associated. In addition, where there are inconsistencies between this application and any document incorporated by reference, it is hereby intended that the present application controls.

1. A method for enhancing autorotation of a rotary-wing aircraft in an emergency event, the method comprising:
receiving a request for emergency thrust from a user interface;
sending a start command to an emergency engine coupled to a rotary-wing aircraft following said request; and
thrusting said rotary-wing aircraft, coupled to said emergency engine, in a direction substantially of a longitudinal axis of said rotary-wing aircraft, thereby enhancing autorotation performance of said rotary-wing aircraft in an emergency event.

2. The method of claim 1, wherein said enhancing is at least one of increasing a flight range of said rotary-wing aircraft, increasing a flight time of said rotary-wing aircraft, decreasing a rate of descent of said rotary-wing aircraft, and increasing an airspeed of said rotary-wing aircraft.

3. The method of claim 1, wherein said thrusting is provided for a time between 1 second and 10 minutes.

4. The method of claim 1, wherein said thrusting is of a variable force, modulated by a user input received from said user interface.

5. The method of claim 1, wherein said emergency engine is a rocket propulsion engine comprising at least one propellant selected from the group consisting of: a solid rocket propellant, a liquid rocket propellant, a gas rocket propellant, a gel rocket propellant, and a hybrid propellant comprising a solid propellant and at least one of a liquid, gas, and gel rocket propellants.

6. The method of claim 1, wherein said emergency engine is a gel-propelled rocket engine that comprises a pressure feed.

7-8. (canceled)

9. The method of claim 1, wherein said emergency event is at least one of an engine failure, a vortex ring state, a tail rotor failure, and a loss of tail-rotor effectiveness (LTE).

10. The method of claim 1, wherein said emergency engine is angled relative to said longitudinal axis to pass through a center of mass of said rotary-wing aircraft and avoid affecting an attitude of said rotary-wing aircraft during flight thus avoiding negative effect on the control and stability of said rotary-wing aircraft.

11. An emergency engine system for enhancing autorotation of a rotary-wing aircraft in an emergency event, the system comprising:
a user interface in a cockpit of a rotary-wing aircraft, wherein said user interface comprises at least one control for receiving a request for emergency thrust from a pilot of said rotary-wing aircraft;
a control unit configured to receive a pilot input from said user interface; and
at least one emergency engine mechanically coupled to said rotary-wing aircraft, wherein said at least one emergency engine is logically connected to said user interface for receiving a start command from said user interface following said request,
wherein when said at least one emergency engine receives said start command from said user interface said rotary-wing aircraft coupled to said at least one emergency engine is thrusted in a direction substantially of a longitudinal axis of said rotary-wing aircraft, thereby enhancing autorotation performance of said rotary-wing aircraft in an emergency event.

12. The emergency engine system of claim 11, wherein said enhancing is at least one of: increasing a flight distance of said rotary-wing aircraft, increasing a flight time of said rotary-wing aircraft, decreasing a rate of descent of said rotary-wing aircraft, and increasing an airspeed of said rotary-wing aircraft.

13. The emergency engine system of claim 11, further comprising a pressurizing system for injecting at least one propellant into at least one combustion chamber of respective said at least one emergency engine, wherein said at least one propellant is ignited in said at least one combustion chamber thereby providing thrust to said rotary-wing aircraft.

14. The emergency engine system of claim 13, wherein said at least one propellant comprises a gel-based rocket propellant.

15. The emergency engine system of claim 13, wherein said at least one propellant selected from the group consisting of: a solid rocket propellant, a liquid rocket propellant, a gas rocket propellant, a gel rocket propellant, and a hybrid propellant comprising a solid propellant and at least one of a liquid, gas, and gel rocket propellants.

16-18. (canceled)

19. The emergency engine system of claim 13, wherein said pressurizing system comprises at least one of a piston, a bladder, and a diaphragm incorporated in respective said at least one propellant tank.

20. The emergency engine system of claim 13, further comprising at least one movable nozzle connected to respective at least one combustion chamber, wherein said movable nozzle comprises a deflector to direct some of said thrust to control a change a body angle of said aircraft.

21-22. (canceled)

23. The emergency engine system of claim 11, wherein said control unit is configured to receive sensor values from at least one of said aircraft and at least one dedicated engine sensor, for activating said at least one emergency engine.

24. The emergency engine system of claim 11, wherein said control unit is configured to activate said at least one emergency engine fully or partially automatically.

25. (canceled)

26. The emergency engine system of claim 1, wherein said control unit receives sensor values from at least one of said aircraft and at least one dedicated sensor.

27. The emergency engine system of claim 11, wherein said at least one emergency engine comprises a left-side emergency sub-engine coupled to a left side of said aircraft and a right-side emergency sub-engine coupled to a right side of said aircraft, wherein said left-side emergency sub-engine and said right-side emergency sub-engine produce different values of thrust force, thereby providing at least some lateral thrust to said aircraft to control a yaw angle of said aircraft.

28. (canceled)

29. The emergency engine system of claim 26, wherein said at least one control of said user interface is coupled to at least one of a throttle and a collective of said aircraft.

30-35. (canceled)
